(19) United States
(12) Patent Application Publication
(10) Pub. No.: US 2025/0305999 A1
(43) Pub. Date: Oct. 2, 2025

(54) CHROMATOGRAPHY WITH RETENTION TIME FEEDBACK CONTROL

(71) Applicant: Rosemount Inc., Shakopee, MN (US)

(72) Inventor: Edward Xiaoyan Zhang, Cypress, TX (US)

(21) Appl. No.: 18/620,104

(22) Filed: Mar. 28, 2024

(51) Int. Cl. G01N 30/86; G01N 30/02; G01N 30/20; G01N 30/32; G01N 30/46

(52) U.S. Cl. CPC G01N 30/8668; G01N 30/20; G01N 30/32; G01N 30/46; G01N 30/8696; G01N 2030/025; G01N 2030/328

(57) ABSTRACT

A gas chromatograph for analyzing content of a gas sample includes a sample gas inlet receiving the sample gas and a carrier gas source providing a carrier gas. A separation column having an inlet and an outlet. A sample valve injects the sample gas and the carrier gas into the separation column inlet at a pressure. Individual component gases in the sample gas separate as they move through the column, and each individual component gas exits the outlet at a component gas retention time which is a function of the individual component gas and the pressure. A detector detects individual component gases as they exit the separation column outlet. A controller coupled to the detector identifies the individual component gases based upon the component gas retention time. The controller calibrates the pressure based upon a component gas retention time.

### BACKGROUND

Gas chromatography is a technique used to analyze a mixture of chemical compounds by separating them into individual components due to their differing migration rates through a chromatographic column. This separates the compounds based on differences in boiling points, polarity, molecular size, or other factors. The separated compounds are then analyzed by a suitable detector, such as a flame photometric detector (FPD), that determines the concentration and/or presence of each compound represented in the overall sample. Knowing the concentration or presence of the individual compounds makes it possible to calculate certain physical properties such as BTU or a specific gravity using industry-standard equations.

In operation, a sample is injected into a chromatographic separation column filled with a packing material. Typically, the packing material is referred to as a “stationary phase” as it remains fixed within the column. A supply of inert carrier gas is provided to the column to force the injected sample through the stationary phase. The inert carrier gas is referred to as the “mobile phase” since it transits the column.

As the mobile phase pushes the sample through the column, various forces cause the constituents of the sample to separate. For example, heavier components move more slowly through the column relative to the lighter components. This causes the sample gases to separate into its individual component gases which, in turn, exit the column in a process called elution. The resulting individual component gases are then fed into a detector that responds to some physical trait of the eluting components.

Over time, the packing material in the chromatographic separation column degrades. This degradation causes changes in the time it takes the individual component gases to pass through the column (known as the “retention time”). As the retention time is used to identify the individual component gasses, eventually the degradation of the packing material can lead to errors in the analysis of the sample gas.

### SUMMARY

A gas chromatograph for analyzing content of a gas sample includes a sample gas inlet configured to receive the sample gas and a carrier gas source which provides a carrier gas. A first separation column has an inlet and an outlet. A first sample valve is coupled to the sample gas inlet and the carrier gas source and is configured to inject the sample gas and the carrier gas into the first separation column inlet at a first pressure. The individual component gases in the sample gas separate as they move through the first column, and each individual component gas exits the outlet at a component gas retention time which is a function of the individual component gas and the first pressure. A detector detects individual component gases as they exit the first separation column outlet. A controller coupled to the detector identifies the individual component gases based upon the component gas retention time. The controller calibrates the first pressure based upon a component gas retention time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a gas chromatograph.

FIG. 2 is a more detailed block diagram showing components of the gas chromatograph of FIG. 1.

FIG. 3 is a side cross-sectional view of particles contained in a separation column of a gas chromatograph.

FIG. 4 is a side cross-sectional view of the particles of FIG. 3 after the particles have broken down into smaller particles.

FIG. 5 shows a path of a gas flowing through a separation column with a gas chromatograph.

FIG. 6 is a plot showing a shift in retention times of individual gas components as they emerge from a separation column in a gas chromatograph.

FIG. 7 is a simplified block diagram showing pressures of a gas as it flows through a separation column of a gas chromatograph.

FIG. 8 is a simplified diagram showing calibration of pressures applied to separation columns of a gas chromatograph in accordance with the present invention.

FIG. 9 is a diagram showing an analytical run of gas through separation columns and a gas chromatograph after calibration.

FIG. 10 is a simplified block diagram showing calibration steps of a gas chromatograph using feedback in accordance with the present invention.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms, and should not be construed as limited to the specific embodiments set forth herein. Rather, these embodiments are provided so that this disclosure will be thorough and complete, and will fully convey the scope of the present disclosure to those skilled in the art.

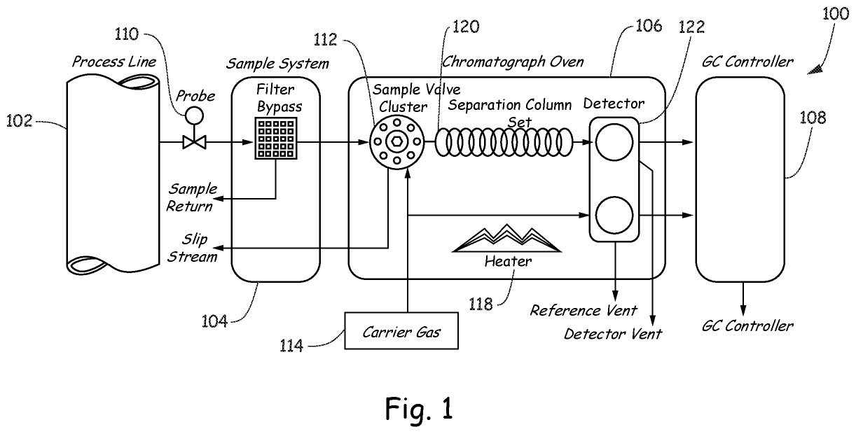

FIG. 1 is a simplified diagram of a gas chromatograph 100 in accordance with one example embodiment of the present invention. Gas chromatograph 100 couples to a process line or piping 102 carrying a process fluid. As used herein, process fluid refers to both liquid and gas phase substances, or their combination. The gas chromatograph 100 includes a sample system 104, a chromatograph oven 106 and a controller 108. The sample system 104 couples to the process line 102 through a probe 110 having a valve therein. Sample system 104 includes a filter which filters undesired components from the sample and provides a sample return. The filtered gas sample is provided to an analytical sample valve cluster 112 in the chromatograph oven 106. Sample valve 112 can comprise any number of individual or compound valves. The chromatograph oven includes a heater 118 which is used to heat components within the oven 106 including the sample valve cluster 112, separation column set 120 and detector 122. Separation column set 120 includes one or more individual separation columns. The sample valve cluster 112 includes at least one valve and is typically a complex valving device which allows valve(s) to be purged prior to analyzing the sample gas, as well as mix a carrier gas from a carrier gas source 114 with the sample gas. The carrier gas is applied at a first pressure and mixed with the gas samples such that the gas sample is forced through a separation column set 120. Individual component gasses in the sample gas separate as they traverse the column set 120.

The separated individual component gases exit the separation column set 120 based upon their component gas retention time, which is partially a function of the pressure of the carrier gas applied to the separation column set 120. The individual component gasses are detected by detector 122, which can also detect the carrier gas as a reference. The detector 122 provides outputs to the gas chromatograph controller 108 which provides an output to an operator indicating the concentration levels of the various individual component gasses present in the sample gas. The controller 108 is also used to control operation of the gas chromatograph 100 including obtaining the sample gas, controlling the timing of the sample valve set 112, controlling the pressure of the carrier gas as it is applied to the sample valve cluster 112 and the separation column set 120, controlling the heater 118 among other things.

The separation column set 120 is filled with packing materials. The breakdown of the packed column materials is an unpreventable process that occurs due to pressure changes caused by flow direction changes and/or analytical valve activation. For example, the various valves in a gas chromatograph can perform back flushing, sampling, control of gas flow between additional separation columns, venting, and other functions. When a valve opens or closes, there is a pressure change in the gas in a separation column. These pressure changes cause the packing material powder in a column to break down into smaller components. The size of the particles that make up the packing material is reduced due to these pressure changes, allowing the smaller particles to move from their original locations and be trapped further downstream in the column set 120. Once these broken-down powders are small enough, they will be discharged from a column and flow into valves and other downstream columns.

This movement of the packing material causes changes in the flow characteristics of the gas chromatograph 100 over time. These changes in flow characteristics cause changes in the flow rate of gas through the gas chromatograph, which in turn cause changes in the retention times of the individual gas components. Once a retention time of any individual component gas shifts out of its predefined range, the controller 108 is unable to accurately identify the gas and an alarm is provided. Service is required to recalibrate the timing of the valves and/or carrier gas pressure.

The retention time shifts due to changes in the packing material are typically a slow process. If a retention time shift is sufficiently small, it is still possible for the controller 108 to identify a component gas. The present invention provides a controller 108 which monitors one or more retention time. Changes in a retention time are used in a feedback loop to adjust the carrier gas pressure to thereby eliminate the retention time shift. In this way, retention time shifts do not accumulate over time.

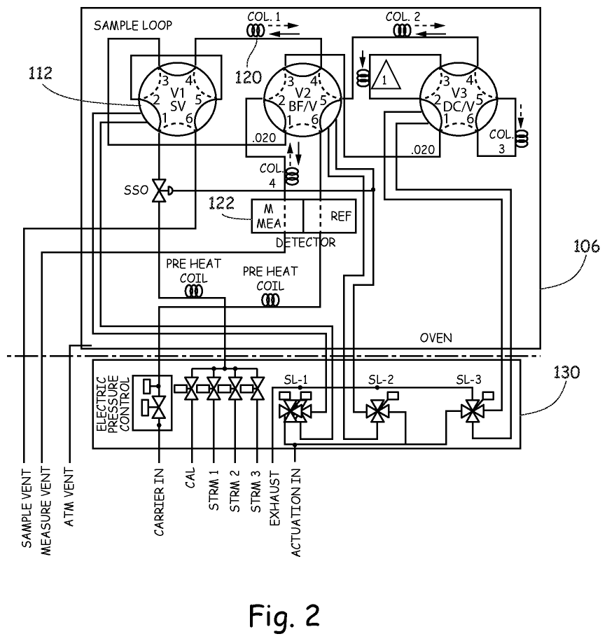

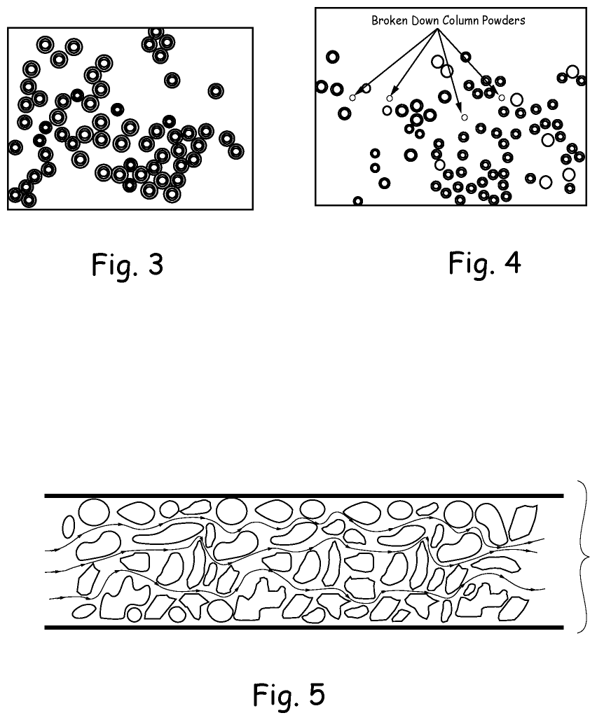

FIG. 2 is a more complex diagram of oven 106 of gas chromatograph 100 shown in FIG. 1. FIG. 2 illustrates multiple separation columns and multiple analytical valves used to control gas flow. The carrier gas pressure can change momentarily when sample valve V1 (112) is activated because of the pressure of sample gas in the sample loop changing from ambient pressure to the pressure of carrier gas. The direction of carrier flow changes when back flush valve V2 is activated, which can cause a momentary pressure drop cross in column 1 (120) of up to 20 PSI. Pressure drops can also occur across columns 2, 3, and 4. The small relative motion among particles of the column packing material caused by these pressure changes and/or flow direction changes cause the material to break down. Column 1 material breaks down much faster than other columns because flow of direction changes and higher-pressure changes across column 1. FIG. 3 is a cross-sectional view of fresh column packing material. FIG. 4 is a cross-sectional view of the same column packing material after it breaks down into smaller particles due to pressure changes.

FIG. 5 illustrates flow of a gas through a packed column 120. Broken-down column packing material becomes small enough to leave its original location and travel with the gas flow. The small pieces of packing material can be trapped downstream in gaps which are less than their physical size. This can occur in the original column of the packing material, or in downstream columns. Packing material leaving its original location causes the flow path at the original location to enlarge and thereby increases flow rate. Further, packing material which is trapped downstream will narrow the flow path and reduce the flow rate. This dynamic process changes the flow characteristics of the gas chromatograph and the resultant gas component retention times. The retention times can become shorter or longer due to this process.

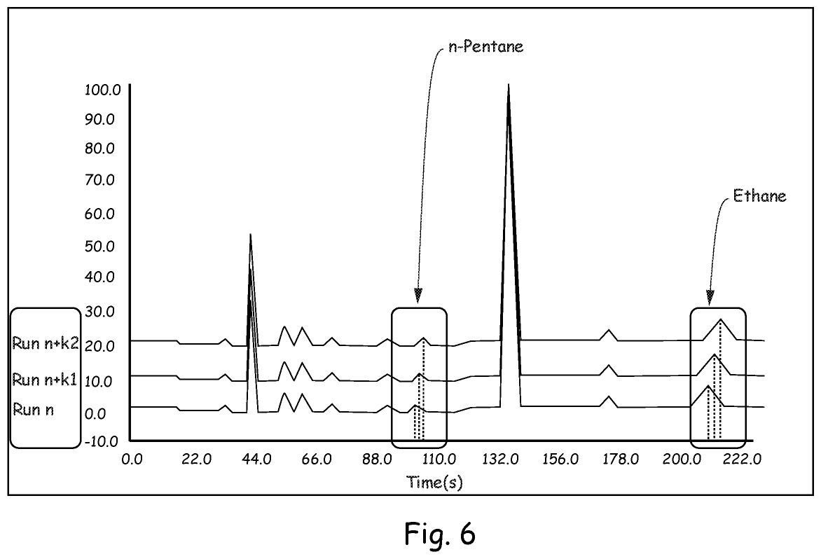

FIG. 6 is a graph of individual component gas concentration versus retention time as a series of three gas sample runs exit a gas chromatograph. Each peak represents the concentration of an individual component gas, and the position of a peak corresponds to retention time for the individual component gas, which is used to identify the component gas. As illustrated in FIG. 6, the retention times shift slightly after each gas sample is run through the gas chromatograph. FIG. 6 shows the trend of retention times of n-Pentane and Ethane over three runs of a period of time. In this example, both retention times shift in the same direction and become longer. However, retention times can also shift in the opposite direction and become shorter.

As discussed above, retention time shifts are caused by a process of column packing material breakdown, which is random depending on the column packing process and the pressure changes applied to a column. Although this breakdown can be mitigated, it is typically not possible to completely eliminate this process. Further, experiments have shown that packing material in some columns break down much faster than others.

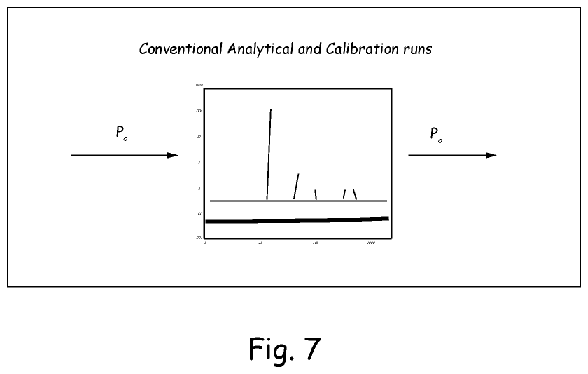

FIG. 7 is a simplified diagram of pressure through a gas chromatograph. Carrier gas at pressure P₀ is kept constant over the time. This is an open loop system. Changes in carrier flow characteristics over time will cause changes in the retention times of the individual component gases of the gas sample.

Referring to the gas chromatograph diagram of FIG. 2, for a BTU measurement configuration, gas component peaks appear during two periods during a run. The first period is between sample valve (SV) V1 OFF and back flush valve (BF/V) V2 ON. Peaks of C6+, i-Butane, n-Butane, Neopentane, i-Pentane, and n-Pentane appear during this period. The second period occurs between BF/V valve ON and the end of cycle, typical at 230 seconds. Peaks of Nitrogen, Methane, Carbon Dioxide, and Ethane appear during this period. (See FIG. 6.)

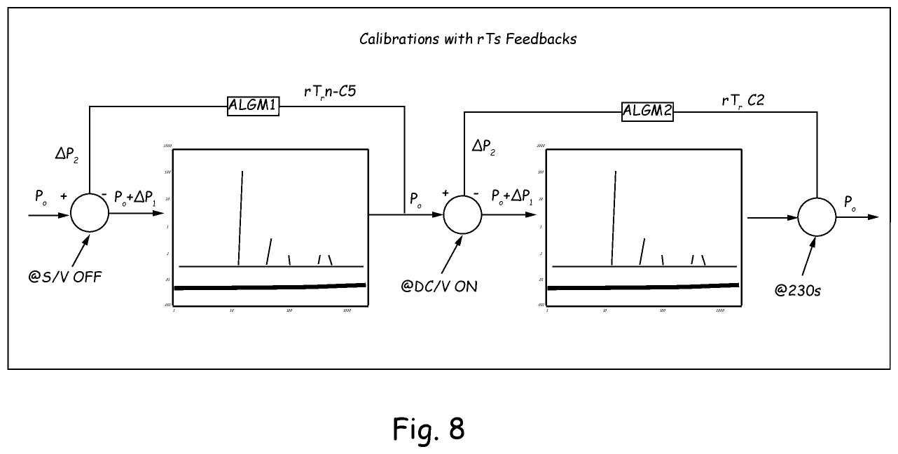

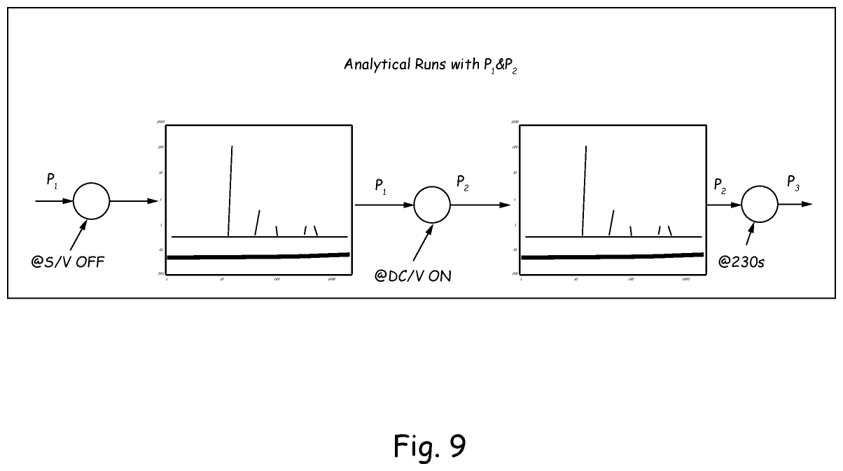

With the present invention, gas chromatograph runs are classified into two groups: calibration runs and analytical runs, as shown in FIGS. 8 and 9. In this example, there are two separation columns which receive a gas sample at pressures P₀+ΔP₁ and P₀+ΔP₂, respectively, which represent the changes in pressure due to breakdown of the packing material. Initially, the gas chromatograph is calibrated with proper valve timing and an initial carrier pressure P₀ as shown in FIG. 7. As the gas chromatograph continually operates with constant pressure P₀, the retention times of the various individual component gases begin to shift as discussed above due to the changing pressure through the columns. In this example, the average of retention times for n-Pentane and Ethane during a past several runs are calculated and compared with their initial retention times. Any number of previous runs can be used to monitor this shift. Compensation pressures ΔP₁ and ΔP₂ are then calculated. For example, ΔP=k*ΔrT, where k is a constant can be obtained from experiment, k is about 0.3 psi/s) However, any feedback algorithm may be used as desired. The pressures of the gas chromatograph are then automatically calibrated with new pressures P₁=P₀+ΔP₁ and P₂=P₀+ΔP₂ as shown in FIG. 8. The moment that P2 is updated can be at any time, as long as the period is sufficiently long for carrier pressure to stabilize before the next component peak occurs. The number of valves, columns and feedback loops will vary based on application. After calibrations, gas chromatograph 100 operates with the new (compensated) pressure settings P1 and P2 as shown in FIG. 9 for normal analytical runs until the next upcoming calibration event. The limits of compensation pressures ΔP₁ and ΔP₂ can be preset. For example, the preset limits can be set based upon the compensation pressures reaching a maximum amount or a maximum allowed change in the applied pressure. If either ΔP₁ or ΔP₂ exceeds their preset limit, an alarm is activated, and service is required. The alarm can be transmitted to service personnel at a remote location, at which time a traditional system calibration can be performed using a sample gas with known individual component gases. Their retention times are measured and the valves, carrier gas pressures, and/or retention time information are calibrated accordingly.

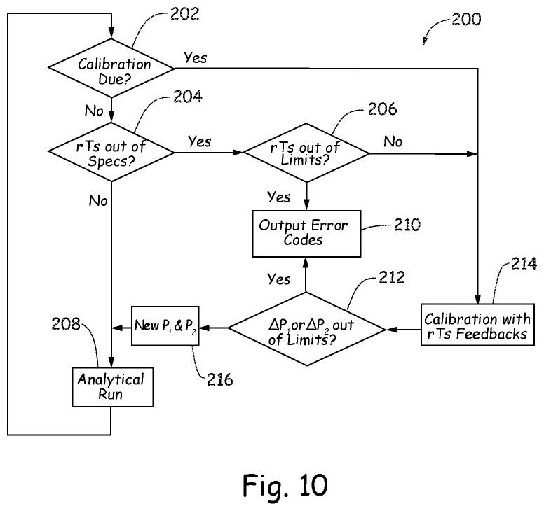

FIG. 10 is a simplified block diagram 200 showing one example of retention time feedback control used to compensate for retention time shifts in a gas chromatograph. In FIG. 10, the feedback process is initiated at block 202. If calibration is due, control is passed to block 214. If calibration is not due at this time, control is passed to block 204. Calibration can be triggered periodically, based upon the receipt of a command from an external source, or by some other means. At block 214, a calibration run is performed in which the measured retention times of known individual sample gasses from one or more prior runs are compared against the original calibrated retention time and ΔP₁ and ΔP₂ are calculated. At block 212 ΔP₁ and ΔP₂ are compared to predetermined maximum limits. If the pressures have drifted beyond the limit, control is passed to block 210 and an error code is provided to an operator which indicates that a full calibration must be performed. If the pressures are within the limits, at block 216 new calibrated carrier gas pressures P₁ and P₂ are calculated. These new carrier gas pressures are then used in subsequent analytical runs, which begin at block 208.

At block 204 the retention times of known individual sample gasses are observed from one or more prior analytical sample runs. If they have drifted beyond a predetermined specified limit, control is passed to block 206. If the retention time is still within specification, control is passed to block 208 and subsequent analytical runs may be performed. At block 206 if the observed sample gas retention times are beyond predetermined limits, an error code is output to an operator at block 210 indicated that calibration must be performed. If the retention times are within limits, control is passed to block 214 and an automated calibration run can be performed as discussed herein.

Although the present invention has been described with reference to preferred embodiments, workers skilled in the art will recognize that changes may be made in form and detail without departing from the spirit and scope of the invention.

What is claimed is:

1. A gas chromatograph for analyzing content of a gas sample, comprising:
a sample gas inlet configured to receive the sample gas;
a carrier gas source which provides a carrier gas;
a first separation column having a first separation column inlet and a first separation column outlet;
a first sample valve coupled to the sample gas inlet and the carrier gas source configured to inject the sample gas and the carrier gas into the first separation column inlet at a first pressure, wherein individual component gases in the sample gas separate as they move through the first column, wherein each individual component gas exits the outlet at a component gas retention time which is a function of the individual component gas and the first pressure;
a detector configured to detect individual component gases as they exit the first separation column outlet; and
a controller coupled to the detector configured to identify an individual component gas based upon the component gas retention times, the controller further configured to calibrate the first pressure based upon at least one component gas retention time.

2. The gas chromatograph of claim 1 including a second separation column and the sample gas is applied to the second separation column at a second pressure.

3. The gas chromatograph of claim 2 wherein the controller further calibrates the second pressure based upon a second component gas retention time.

4. The gas chromatograph of claim 1 wherein a change in a component gas retention time is compared with a maximum allowed change in component gas retention time.

5. The gas chromatograph of claim 4 wherein an alarm is provided based upon the comparison.

6. The gas chromatograph of claim 1 wherein a change in the first applied pressure due to calibration is compared to a maximum allowed pressure change.

7. The gas chromatograph of claim 6 wherein an alarm is provided based upon the comparison.

8. The gas chromatograph of claim 1 wherein the first pressure is calibrated based on a feedback algorithm.

9. The gas chromatograph of claim 8 wherein a calibrated pressure is calculated based on a difference between an initial calibrated retention time and an average of previously measured retention times.

10. The gas chromatograph of claim 1 wherein calibration is performed in response to a change in measured retention time of an individual component gas.

11. The gas chromatograph of claim 1 including a plurality of applied pressures and wherein compensation pressures are determined for each of the plurality of applied pressures based on changes in a plurality of individual component gas retention times.

12. A method of calibrating a gas chromatograph of the type used to analyze content of a gas sample, comprising:
receiving a sample gas;
providing a carrier gas at a first pressure;
providing a first separation column having a first separation column inlet and a first separation column outlet;
injecting the sample gas and the carrier gas into the first separation column inlet at the first pressure using a first sample valve, wherein individual component gases in the sample gas separate as they move through the first column, wherein each individual component gas exits the outlet at a component gas retention time which is a function of the individual component gas and the first pressure;
detecting individual component gases as they exit the first separation column outlet; and
identifying an individual component gas based upon the component gas retention times, and further calibrating the first pressure based upon a change in at least one component gas retention time.

13. The method of claim 12 including providing a second separation column and the sample gas is applied to the second separation column at a second pressure.

14. The method of claim 13 including calibrating the second pressure based upon a second component gas retention time.

15. The method of claim 12 wherein a change in a component gas retention time is compared with a maximum allowed change in component gas retention time.

16. The method of claim 15 including providing an alarm based upon the comparison.

17. The method of claim 12 wherein a change in the first applied pressure due to calibration is compared to a maximum allowed pressure change.

18. The method of claim 17 including providing an alarm based upon the comparison.

19. The method of claim 12 wherein the first pressure is calibrated based on a feedback algorithm.

20. The method of claim 19 wherein a calibrated pressure is calculated based on a difference between an initial calibrated retention time and an average of previously measured retention times.
